(19) United States
(12) Patent Application Publication
(10) Pub. No.: US 2023/0267569 A1
(43) Pub. Date: Aug. 24, 2023

(54) ACCELERATION OF GPUS IN CLOUD COMPUTING

(71) Applicant: Huawei Technologies Co., Ltd., Shenzhen (CN)

(72) Inventors: Yingxuan Zhu, Cambridge, MA (US); Yong Wang, Westborough, MA (US); Theodoros Gkountouvas, Burlington, MA (US); Han Su, Ann Arbor, MI (US); Hui Lei, Scarsdale, NY (US)

(73) Assignee: Huawei Technologies Co., Ltd., Shenzhen (CN)

(21) Appl. No.: 18/306,437

(22) Filed: Apr. 25, 2023

Related U.S. Application Data
(63) Continuation of application No. PCT/US2021/021113, filed on Mar. 5, 2021.

(51) Int. Cl. G06T 1/20; G06F 9/50; G06F 9/48

(52) U.S. Cl. CPC G06T 1/20; G06F 9/5027; G06F 9/4881

(57) ABSTRACT

The disclosure relates to technology for acceleration of GPUs in cloud. Instructions for a computational task are accessed. An allocation of data and instructions is calculated based on the data, the instructions, and dynamic GPU resources. The data and the instructions are provided to the GPUs in accordance with the allocation, which includes scheduling a set of instructions for parallel computation of an operation of the computational task on multiple sub-matrices of a data matrix. Separate portions of information are stored into corresponding different regions of non-transitory memory of a processor core to provide concurrent access to the multiple sub-matrices to the processor core. Each sub-matrix corresponds to a portion of the data matrix for which an operation of the computational task is to be performed. Each sub-matrix contains an element in the data matrix in common with another sub-matrix of the data matrix.

### CLAIM OF PRIORITY

This application is a continuation of PCT Patent Application No. PCT/US2021/021113, entitled “ACCELERATION OF GPUS IN CLOUD COMPUTING”, filed Mar. 5, 2021, the entire contents of which is hereby incorporated by reference.

### FIELD

The disclosure generally relates to graphics processing unit (GPU) acceleration in cloud computing.

### BACKGROUND

A graphics processing unit (GPU) is a type of processing unit that enables very efficient parallel processing of data. Although GPUs may be used in a video card or the like for computer graphics, GPUs have found much broader applications. For example, GPUs are used for machine learning, artificial intelligence, scientific computing, etc.

Recently, GPUs have been made available in “the cloud.” The cloud allows for “cloud computing,” which refers to providing computer resources to client devices over a network. The computer resources could include hardware (e.g., GPUs), software applications, and/or storage. The cloud typically refers to servers that provide the computer resources. A company may provide a cloud computing service that provides access to GPUs over a network, such as the Internet. The company typically has a number of servers on which the GPUs reside, possibly along with other types of processors. A client computing device may access the GPUs by communicating with the servers(s) via the Internet, or another type of network. Hence, the client computing device is able to take advantage of the computational power of the GPUs. The GPUs could include different types of GPUs from the same vendor and/or GPUs from different vendors. Hence, the GPUs could have significantly different GPU resources. For example, the GPUs could differ in the number of processor cores, the number of arithmetic logic units (ALUs) per processor core, as well as the amount of memory per processor core.

However, challenges exist with efficiently operating the GPUs when processing data. Such challenges are especially difficult when there is a large amount of data to process, such as, but not limited to, machine learning. Such challenges exist in cloud computing, but are not limited to cloud computing.

### BRIEF SUMMARY

According to one aspect of the present disclosure, there is provided a computer-implemented method for accelerating computation in graphic processing units (GPU). The method comprises accessing instructions for a computational task having a sequence of operations. The method comprises calculating an allocation of data and an allocation of the instructions for the GPUs based on the data, the instructions, and dynamic GPU resources. The data comprises a plurality of data matrices upon which the operations are to be performed. The method comprises providing the data and the instructions to the GPUs in accordance with the allocation, including scheduling a first set of the instructions for parallel computation of a first operation of the computational task on multiple sub-matrices of a first data matrix of the plurality of data matrices. The first set of the instructions are scheduled for execution in a first processor core of a plurality of processor cores in a first GPU. Each processor core comprises arithmetic logic units (ALUs) and non-transitory memory storage. The first set of the instructions are scheduled for parallel computation in the ALUs. Providing the data and the instructions to the GPUs in accordance with the allocation further includes storing separate portions of information into corresponding different regions of the non-transitory memory storage of the first processor core to provide concurrent access to the multiple sub-matrices to the first processor core. Each portion of information provides access to a different ALU to a different sub-matrix of the first data matrix, each sub-matrix corresponds to a portion of the first data matrix for which a first operation of the computational task is to be performed, each sub-matrix contains an element in the first data matrix in common with another sub-matrix of the first data matrix, and the separate portions of information reside in the different regions of the non-transitory memory storage at the same time. The method comprises accessing a result of the computational task in response to execution of the instructions on the data by the GPUs.

Optionally, in any of the preceding aspects, the method further comprises monitoring the resources of the GPUs as the instructions are executed on the data by the GPUs, and adjusting the allocation of the data and the instructions based on a change in available GPU resources.

Optionally, in any of the preceding aspects, providing the data and the instructions to the GPUs in accordance with the allocation further comprises: identifying instructions that are sharable between a first operation in a first layer of the computational task and a second operation in a second layer of the computational task; and scheduling the sharable instructions to be executed on the first GPU without removal of the sharable instructions between computation for the first operation and the second operation.

Optionally, in any of the preceding aspects, storing separate portions of information into corresponding different regions of the non-transitory memory storage of the first processor core to provide concurrent access to the multiple sub-matrices to the first processor core comprises storing the multiple sub-matrices of the first data matrix into the different regions of the non-transitory memory storage that is accessible to the first processor core.

Optionally, in any of the preceding aspects, the method further comprises retaining the multiple sub-matrices in the different regions of the non-transitory memory storage after the first set of the instructions are executed on the first processor core. The method optionally further comprises scheduling a second set of the instructions for parallel computation of a second operation of the computational task in the first processor core, wherein the second set of the instructions are scheduled for parallel computation in the ALUs. And, the method optionally further comprises initiating execution of the second set of the instructions in the first processor core to simultaneously apply the second set of the instructions to the multiple sub-matrices while the multiple sub-matrices are maintained in the different regions of the non-transitory memory storage.

Optionally, in any of the preceding aspects, storing separate portions of information into corresponding different regions of the non-transitory memory storage of the first processor core to provide concurrent access to the multiple sub-matrices to the first processor core comprises storing pointers in the different regions of the non-transitory memory storage of the first processor core, wherein each pointer points to a different sub-matrix of the multiple sub-matrices. The pointers reside in the different regions of the non-transitory memory storage at the same time, wherein the multiple sub-matrices reside in non-transitory memory storage external to the first processor core.

Optionally, in any of the preceding aspects, the method further comprises selecting a size of the multiple sub-matrices based on an amount of non-transitory memory storage that is available in the first processor core.

Optionally, in any of the preceding aspects, the method further comprises selecting a size of the multiple sub-matrices based on an amount of memory needed by the first set of instructions that will be applied to data of the multiple sub-matrices.

Optionally, in any of the preceding aspects, the method further comprises monitoring over a communication network, GPU resources in a server that hosts the GPUs by communicating over the communication network with the server to obtain latest information about available GPU resources in the server. Optionally, the method further comprises accessing specifications of newly available GPU resources. Optionally, the method further comprises calculating an allocation of the data remains to be processed and an allocation of the instructions that remain to be processed to finish a current computational task in GPUs, including newly available GPUs. Optionally, the method further comprises providing the data remains to be processed and the instructions that remain to be processed to the GPUs, including newly available GPUs, in accordance with the allocation of the data remains to be processed and the allocation of the instructions that remain to be processed.

Optionally, in any of the preceding aspects, the method further comprises communicating, by a first server that hosts the GPUs with a second server over a communication network, to obtain information of GPU resources on the second server. Optionally, the method further comprises obtaining permissions to use the GPU resources on the second server; calculating an allocation of the data remains to be processed and an allocation of the instructions that remain to be processed based on the GPU resources on both the first server and the second server; providing a first portion of the data remain to be processed and a first portion of the instructions that remain to be processed to the GPUs in the first server based on the allocation of the data remains to be processed and the allocation of the instructions that remain to be processed; and providing a second portion of data remain to be processed and a second portion of the instructions that remain to be processed to the GPUs in the first server based on the allocation of the data remains to be processed and the allocation of the instructions that remain to be processed.

Optionally, in any of the preceding aspects, the method further comprises identifying types of parallelization that can be performed among the data and among the instructions; calculating data and instructions that are needed to implement parallelizations with constraints of GPU availability and specifications, wherein the GPU availability and specifications identify available processor cores in the GPUs; calculating a minimum size of data needed for a set of instructions in each processor core; and calculating a maximum size of data set each processor core can have according to a number of available processor cores.

Optionally, in any of the preceding aspects, the computational task comprises an artificial neural network.

According to still one other aspect of the present disclosure, there is provided a non-transitory computer-readable medium storing computer executable instructions for accelerating computation in graphics processing units (GPUs) that, when executed by one or more processors, cause the one or more processors to access computational instructions for a computational task having a sequence of operations, and calculate an allocation of data and an allocation of the computational instructions for the GPUs based on the data, the computational instructions, and dynamic GPU resources. The data comprises a plurality of data matrices upon which the operations are to be performed. The instructions further cause the one or more processors to provide the data and the computational instructions to the GPUs in accordance with the allocation, including schedule a first set of the computational instructions for parallel computation of a first operation of the computational task on multiple sub-matrices of a first data matrix of the plurality of data matrices. The first set of the computational instructions are scheduled for execution in a first processor core of a plurality of processor cores in a first GPU. Each processor core comprises arithmetic logic units (ALUs) and non-transitory memory storage. The first set of the computational instructions are scheduled for parallel computation in the ALUs. The instructions further cause the one or more processors to store separate portions of information into corresponding different regions of the non-transitory memory storage of the first processor core to provide concurrent access to the multiple sub-matrices to the first processor core. Each portion of information provides access to a different ALU to a different sub-matrix of the first data matrix, each sub-matrix corresponds to a portion of the first data matrix for which a first operation of the computational task is to be performed, each sub-matrix contains an element in the first data matrix in common with another sub-matrix of the first data matrix, and the separate portions of information reside in the different regions of the non-transitory memory storage at the same time. The instructions further cause the one or more processors to access a result of the computational task in response to execution of the computational instructions on the data by the GPUs.

According to still one other aspect of the present disclosure, there is provided a system for accelerating computation of graphics processing units (GPUs). The system comprises a non-transitory memory storage comprising computer executable instructions, and one or more processors in communication with the non-transitory memory storage. The one or more processors execute the computer executable instructions to: access computational instructions for a computational task having a sequence of operations; calculate an allocation of data and an allocation of the computational instructions for the GPUs based on the data, the computational instructions, and dynamic GPU resources, wherein the data comprises a plurality of data matrices upon which the operations are to be performed. The one or more processors execute the computer executable instructions to provide the data and the computational instructions to the GPUs in accordance with the allocation, including schedule a first set of the computational instructions for parallel computation of a first operation of the computational task on multiple sub-matrices of a first data matrix of the plurality of data matrices. The first set of the computational instructions are scheduled for execution in a first processor core of a plurality of processor cores in a first GPU. Each processor core comprises arithmetic logic units (ALUs) and non-transitory memory storage. The first set of the computational instructions are scheduled for parallel computation in the ALUs. The one or more processors execute the computer executable instructions to store separate portions of information into corresponding different regions of the non-transitory memory storage of the first processor core to provide concurrent access to the multiple sub-matrices to the first processor core. Each portion of information provides access to a different ALU to a different sub-matrix of the first data matrix, each sub-matrix corresponds to a portion of the first data matrix for which a first operation of the computational task is to be performed, each sub-matrix contains an element in the first data matrix in common with another sub-matrix of the first data matrix, and the separate portions of information reside in the different regions of the non-transitory memory storage at the same time. The one or more processors execute the computer executable instructions to access a result of the computational task in response to execution of the computational instructions on the data by the GPUs.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

Aspects of the present disclosure are illustrated by way of example and are not limited by the accompanying figures for which like references indicate elements.

FIG. 1 illustrates an example system in which GPU acceleration can operate.

FIG. 2 depicts a schematic example of a computational task.

FIG. 3 depicts one embodiment of a GPU accelerator.

FIG. 4A depicts an embodiment of duplicating data to accelerate GPU computation.

FIG. 4B depicts an embodiment of using pointers to accelerate GPU computation.

FIG. 5 depicts a conventional art process of performing convolution in a CNN.

FIG. 6 depicts an embodiment of duplicating data to accelerate GPU computation.

FIG. 7 is a flowchart of one embodiment of a process of accelerating computation on a GPU.

FIG. 8 is a flowchart of one embodiment of a process of accelerating GPU performance.

FIG. 9 is a flowchart of one embodiment of a process of performing computation for a CNN on a GPU in which data is duplicated in order to accelerate performance on the GPU.

FIG. 10 is a flowchart of one embodiment of a process of executing multiple operations for the same layer of a CNN on the same data set.

FIG. 11 is a flowchart of one embodiment of a process of sharing computational instructions across layers of a CNN.

FIG. 12 is a flowchart of one embodiment of a process of loading data into memory on a processor core.

FIG. 13 depicts such an example in which four sub-matrices are loaded into GPU memory.

FIG. 14 is a flowchart of one embodiment of a process of GPU acceleration.

FIG. 15 depicts an example GPU.

FIG. 16 illustrates a computing system upon embodiments of the disclosure may be implemented.

### DETAILED DESCRIPTION

The present disclosure will now be described with reference to the figures. The technology relates to GPU acceleration. In some embodiments, the GPUs reside in a cloud computing environment. The GPUs may be used to perform a computational task that typically has a number of operations. The computational task may be performed by executing computational instructions on GPUs.

One technical challenge is that a GPU may sit idle while waiting for data to process. One reason for this idleness is that the computational task may have data dependencies, wherein the result of one operation are the input to another operation. Hence, a GPU that is to perform a downstream operation may sit idle waiting for a result from an upstream operation. Also, in some conventional techniques, data that could be processed in parallel on a GPU is not processed in parallel. In some embodiments, data is “duplicated” in order to achieve better data parallelism. An embodiment includes, scheduling a set of computational instructions for parallel computation of a first operation of the computational task on multiple sub-matrices of a data matrix, which increases GPU efficiency.

Another technical challenge is to efficiently schedule and/or load the computational instructions onto the GPU(s). In some embodiments, the computational instructions are scheduled in a manner that allows the computational instructions to be shared by different operations of the computational task. An embodiment includes, identifying instructions that are sharable between a first operation in a first layer of the computational task and a second operation in a second layer of the computational task, and scheduling the sharable instructions to be executed on a GPU without removal of the sharable instructions between computation for the first operation and the second operation, which increases GPU efficiency.

Another technical challenge is that the GPU resources that are available to perform the computational task can change over time. In an embodiment, the resources of one or more GPUs are monitored in real time. For example, the resources of the GPUs are monitored as the computational instructions are executed on the data by the GPUs. An allocation of data and computational instructions is adjusted based on a change in available GPU resources, which increases GPU efficiency.

It is understood that the present embodiments of the disclosure may be implemented in many different forms and that claim scope should not be construed as being limited to the embodiments set forth herein. Rather, these embodiments are provided so that this disclosure will be thorough and complete and will fully convey the inventive embodiment concepts to those skilled in the art. Indeed, the disclosure is intended to cover alternatives, modifications and equivalents of these embodiments, which are included within the scope and spirit of the disclosure as defined by the appended claims. Furthermore, in the following detailed description of the present embodiments of the disclosure, numerous specific details are set forth in order to provide a thorough understanding. However, it will be clear to those of ordinary skill in the art that the present embodiments of the disclosure may be practiced without such specific details.

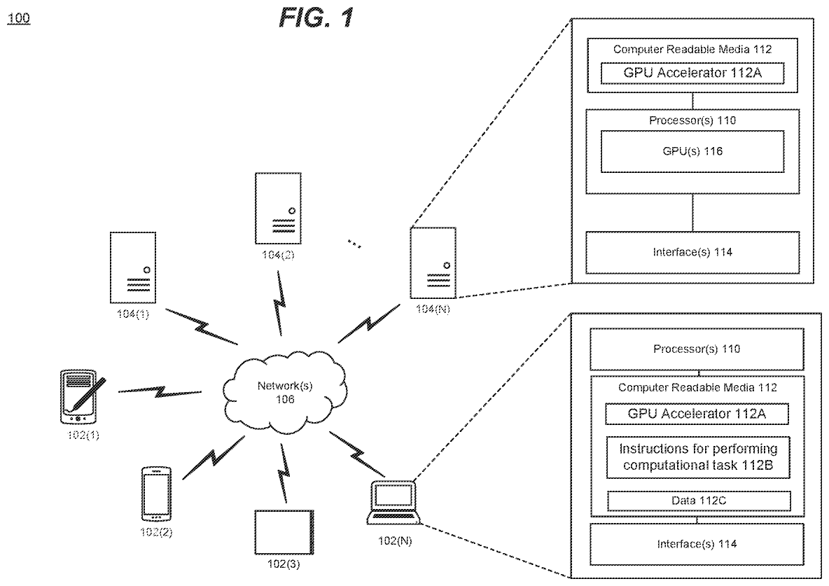

FIG. 1 illustrates an example system in which GPU acceleration can operate. The system 100 includes one or more computing devices 102(1)-102(N), including servers 104(1)-104(N), that may communicate with one another via one or more networks 106. Networks 106 may be wired or wireless and include public networks or private networks including, but not limited to local area networks (LAN), wide area networks (WANs), satellite networks, cable networks, WiMaX networks, and communication networks, such as LTE and 5G networks. Networks 106 may also include any number of different devices that facilitate network communications, such as switches, routers, gateways, access points, firewalls, base stations, repeaters, backbone devices, etc.

Servers 104(1)-104(N) make their GPUs 116 available to computing devices 102(1)-102(N) over the network(s) 106. One or more of the servers 104(1)-104(N) may provide what is commonly referred to as a “cloud computing service,” which allows the computing devices 102(1)-102(N) to access the GPUs 116 through network(s) 106. In an embodiment, a server 104 has a GPU accelerator 112A, which accelerates computation performed by GPU(s) 116.

Servers 104(1)-104(N) each have processor(s) 110, computer readable media 112, and interfaces 114. The processor(s) may operate to execute instructions stored on the computer readable media 112, which may include for example, a GPU accelerator 112A. Processor(s) 110 may include, but are not limited to, one or more single-core processors, multi-core processors, CPUs, graphics processing units (GPUs) 116, general purpose graphics processing units (GPGPUs) or hardware logic components, such as accelerators and field-programmable gate arrays (FPGAs), application-specific integrated circuits (ASICs), system-on-a-chip (SoCs), complex programmable logic devices (CPLDs) and digital signal processors (DSPs).

Computing device(s) 102(1)-102(N) may include, but are not limited to, any number of various devices, such as client or server based devices, desktop computers, mobile devices, special purposes devices, wearable devices, laptops, tablets, cell phones, automotive devices, servers, telecommunication devices, network enabled televisions, games consoles or devices, cameras, set top boxes, personal data assistants (PDAs) or any other computing device.

Computing device(s) 102(1)-102(N) each have processor(s) 110, computer readable media 112, and interfaces 114. Processor(s) 110 may include, but is not limited to, one or more single-core processors, multi-core processors, CPUs, graphics processing units (GPUs), general purpose graphics processing units (GPGPUs) or hardware logic components, such as accelerators and field-programmable gate arrays (FPGAs), application-specific integrated circuits (ASICs), system-on-a-chip (SoCs), complex programmable logic devices (CPLDs) and digital signal processors (DSPs).

The processor(s) 110 of the computing device 102 may operate to execute instructions stored on the computer readable media 112, which may be for example, a GPU accelerator 112A, instructions for performing a computational task 112B, and data for the computational task (input data 112C), and other programs or applications executable by processor(s) 110. The instructions for performing a computational task 1128 are executed on one or more GPUs 116 in order to perform the computational task. In one embodiment, a computing device 102 uses the GPU accelerator 112A to accelerate computation on a GPU on the computing device 102. The GPU accelerator 112A on the computing device 102 is optional. In some embodiments, the computing device 102 communicates with a server 104 to gain access to GPU(s) in the cloud, such that the computing device 102 is able to use the cloud based GPUs to perform a computational task.

Computer readable media 112 (or memory) may include computer storage media and/or communication media, which may comprise tangible storage units such as volatile memory, non-volatile memory or other persistent or auxiliary computer storage media, removable and non-removable computer storage media implemented in any method or technology for storage of information such as computer readable instructions, data structures or other data. In an embodiment, the computer readable media is non-transitory memory storage. Computer readable media 112 may include tangible or physical forms of media found in device or hardware components, including but not limited to, random access memory (RAM), static RAM, dynamic RAM, read only memory (ROM), erasable programmable ROM (EPROM), electrically erasable programmable ROM (EEPROM), flash memory, optical storage, magnetic storage, storage arrays, network storage, storage area networks or any other medium that may be used to store and maintain information for access by a computing device, such as computer devices 102(1)-102(N) and 104(1)-104(N). In some embodiments, computer readable media 112 can store instructions executable by the processor(s) 110, which processor(s) 110 may be included in one or more of the computer devices 102(1)-102(N) and 104(1)-104(N). In still other embodiments, the computer readable media 112 may store an operating system which includes components to enable or direct the computing devices 102(1)-102(N) and 104(1)-104(N) to receive data via various input (e.g., memory devices, user controls, network interfaces, etc.) and process the data using processor(s) 110 to generate output (e.g., and image for display, data for storing in memory, etc.).

The one or more communications interfaces 114 enable wired or wireless communications between the computing device 102(1)-102(N) and 104(1)-104(N) involved in GPU acceleration. Communications interface(s) 114 may include one or more transceiver devices, for example, network interface controllers (NICs) such as Ethernet NICs, to send and receive communications over a network, such as network 106. In one embodiment, the processor(s) 110 may exchange data through the communications interface 114. For example, the communications interface 114 may be a Peripheral Component Interconnect express (PCIe) transceiver. Other examples include the communications interface 114 being a transceiver for cellular, Wi-Fi, Ultra-wideband (UWB), BLUETOOTH or satellite transmissions. The communications interface 114 can include a wired I/O interface, such as an Ethernet interface, a serial interface, a Universal Serial Bus (USB) interface, an INFINIBAND interface other wired interfaces.

In some embodiments, the computational task includes a machine learning algorithm. However, the computational task is not limited to machine learning, as many types of computational tasks can be performed on GPUs. Machine learning describes a wide range of algorithms by which a computer can learn to solve a problem without being explicitly programmed. One class of machine learning algorithm is artificial neural networks. An artificial neural network comprises a set of interconnected nodes. One or more input nodes receive external input data. The input nodes apply an activation function to the input and may output the result to one or more other nodes (referred to as “hidden nodes”). The hidden nodes receive input from one or more previous nodes (i.e., the input nodes or another hidden node), applying different weighting factors to each input. The hidden nodes then apply an activation function in much the same way as the input nodes. The output is then passed on to additional nodes, which process it as input. This process continues until the original input has propagated through the artificial neural network and reaches one or more output nodes. An output node applies an activation function in the same manner as other nodes, but rather than passing its output to another node, it outputs a result.

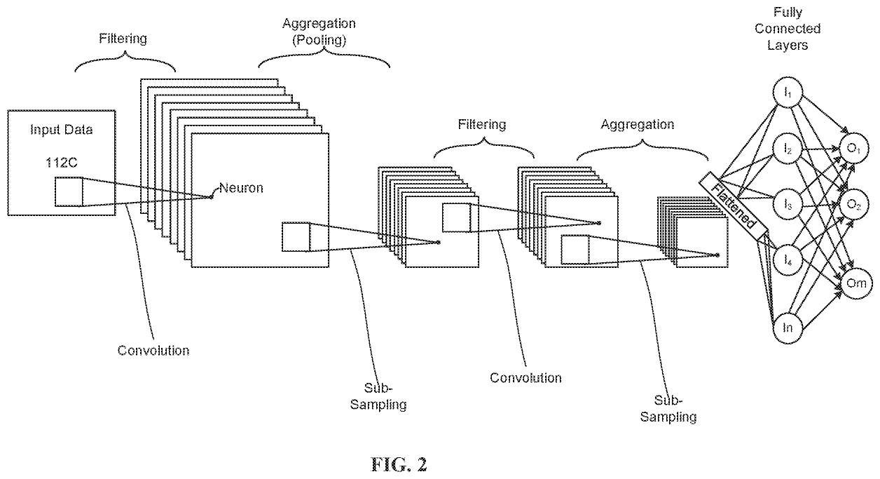

FIG. 2 depicts a schematic example of a computational task. In this case, the computational task is a computational neural network (CNN), which may be used in machine learning. However, the computational task is not limited to machine learning. FIG. 2 illustrates input data 112C which could be, for example, an array of pixel values. The computational task has a number of layers. In the example, there are two convolutional layers, two aggregation layers, and fully connected layers. In the example, in the first convolutional layer, a filter may be applied to the input image by sliding the input region along the image's x and y dimensions to generate the output values of the convolutional layer. The aggregation (or pooling) down-samples to reduce the dimensions of the data. There may be more than two convolutional layers prior to the fully connection layers.

The fully connected layers include input nodes (I1, I2, . . . In) and output nodes (O1, O2 . . . Om). There may be one or more intermediate (or hidden) layers between the input nodes and output nodes, but those are not depicted. The output nodes provide an output result of the computational task.

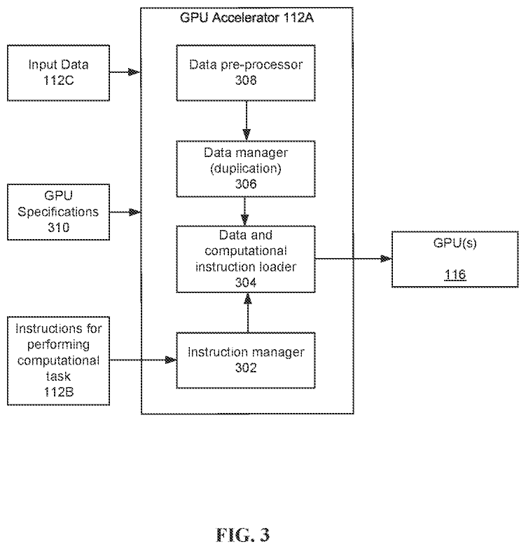

FIG. 3 depicts one embodiment of a GPU accelerator 112A. The GPU accelerator 112A accelerates computation on one or more GPUs 116. In an embodiment, the GPU accelerator 112A comprises instructions stored in computer readable media. Those instructions are executed on a processor in order to accelerate computation on the GPUs 116. The processor that executes the instructions of the GPU accelerator 112A may be, but is not limited to, one or more single-core processors, multi-core processors, central processing units (CPUs), graphics processing units (GPUs), general purpose graphics processing units (GPGPUs) or hardware logic components, such as accelerators and field-programmable gate arrays (FPGAs), application-specific integrated circuits (ASICs), system-on-a-chip (SoCs), complex programmable logic devices (CPLDs) and digital signal processors (DSPs).

In one embodiment, the GPU accelerator 112A is stored in computer readable media on a server, such as cloud server that also has the GPU(s) 116. In some embodiments, the GPU accelerator 112A is executed by one or more of the GPU(s) 116. However, it is not required that the GPU accelerator 112A be executed on a GPU. In one embodiment, the GPU accelerator 112A is executed on a CPU. The CPU may reside on a server, which may or may not contain the GPU 116. In some embodiments, the GPU accelerator 112A is stored in computer readable media on computer device (e.g., client device) that accesses the GPU 116 through a network 106. Hence, the GPU accelerator 112A may be executed by a processor (e.g., CPU) that resides on the client device.

The instructions for performing a computational task 1128 include instructions that are executed on the GPU 116 in order to perform a computation with respect to input data 112C. For brevity, the instructions for performing a computational task 112B may be referred to herein as “computational instructions” 112B. In one embodiment, the computational instructions 112B are used to implement computations (or operations) in the artificial neural network (e.g., CNN). For example, the input data 112C could be images, with the computational task being image recognition. The computational task could be a training phase or an inference phase of the artificial neural network. The computational instructions 1128, when executed on a GPU 116, may perform a number of operations. For example, there could be a convolution (which is an example of an operation to be performed on data) at each of several layers. Moreover, each layer could have other types of operations to be performed on data. In an embodiment, the computational instructions 112B contain sets of instructions that are each for performing an operation. For example, one set of instructions, when executed on a GPU, will perform a convolution operation on a chunk of some data (e.g., a sub-matrix in the input data 112C). As another example, one set of instructions, when executed on a GPU, will perform a binary decision on some chunk of data.

The GPU specifications 310 describe the resources in the GPU(s) 116. The GPU resources may include, but are not limited to, the number of processor cores in the GPU, the number of ALUs per processor core, the amount of memory per processor core. The GPU specifications 310 are in a format that is readable by the GPU accelerator 112A. For example, the GPU specifications 310 may be stored in computer readable media in a format that is readable by a processor. Note that the GPU(s) 116 may contain different types of GPUs that have different GPU resources.

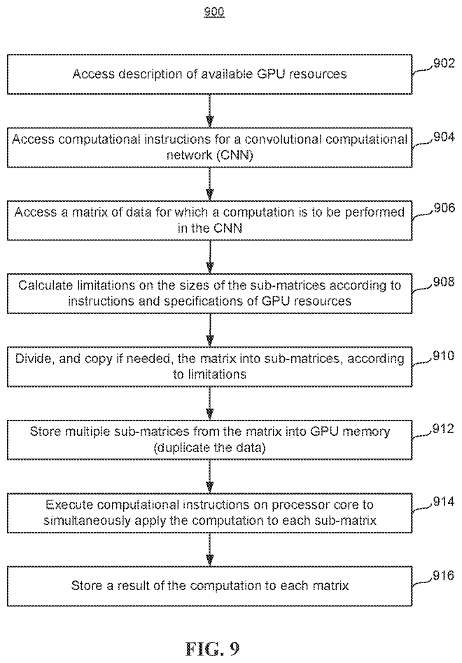

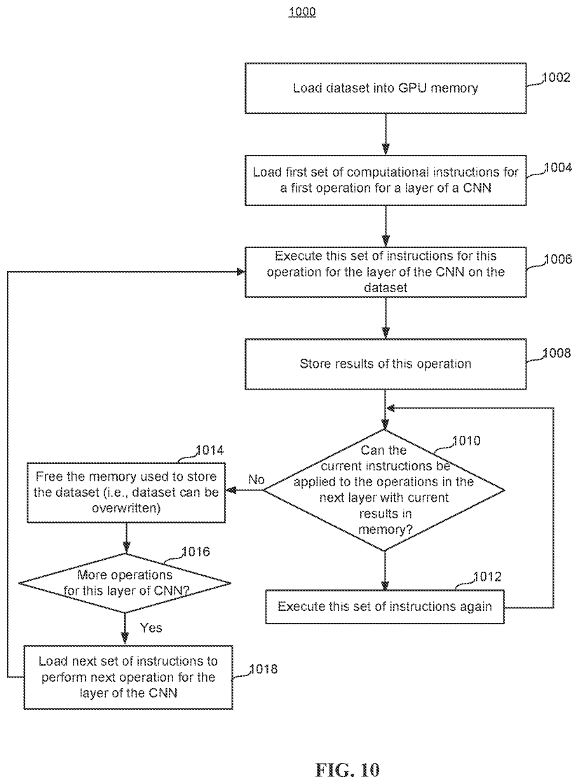

Referring now to the GPU accelerator 112A, the instruction manager 302 determines how to schedule the computational instructions 1128 for execution on the GPU(s) 116 in order to accelerate the computation. In one embodiment, the instruction manager 302 maximizes the instructions scheduled for each core. Compared to CPUs, GPUs have more ALUs but less memory. In order to reduce the time spending in data input/output (I/O) of memory, the capacity of ALU should be maximized by processing as many instructions as possible on the same set of data. This is also a way to provide flexibility in data processing when the overall GPU resources are consistently changing in a cloud. The phrase “maximizes the instructions,” as used herein, means to schedule as many instructions as can presently be scheduled given the GPU resources available, and the computational task. In one embodiment, maximizing the instructions includes executing instructions for different operations against the same data set. In one embodiment, the instructions for all of the operations at a layer of the computational task are executed with respect to a data set while the data set is maintained in memory. Then, the data set is removed from memory, which frees up the memory for a new data set. FIGS. 10 and 11 depict various embodiments of maximizing the instructions.

In one embodiment, the instruction manager 302 schedules the computational instructions 112B for execution on the GPU(s) 116. In one embodiment, the instruction manager 302 schedules a set of the instructions for a GPU to execute for multiple operations of the computational task in sequence. Moreover, the set of the instructions may be kept in the GPU between the operations (e.g. not off-loaded), which increases efficiency and accelerates GPU computation.

The data pre-processor 308 puts the input data 112C into a format that is suitable for computation. The data manager 306 handles duplication of data, which accelerates computation in the GPUs 116. Data duplication may be used to provide over-lapping chunks of data to a GPU for parallel operation.

The data and instruction loader 304 provides data 112C and computational instructions 1128 to the GPU(s) 116. In one embodiment, over-lapping chunks of the data 112C are provided to a GPU for parallel operation of a set of the instructions on the over-lapping chunks. In some embodiments, the data and instruction loader 304 will provide the over-lapping chunks by sending copies of at least some of the input data 112C to the GPU(s) 116. In some embodiments, the data and instruction loader 304 will assign data pointers to the GPU(s) 116. In some embodiments, a first set of computing instructions are scheduled for parallel computation of an operation of the computational task on multiple sub-matrices.

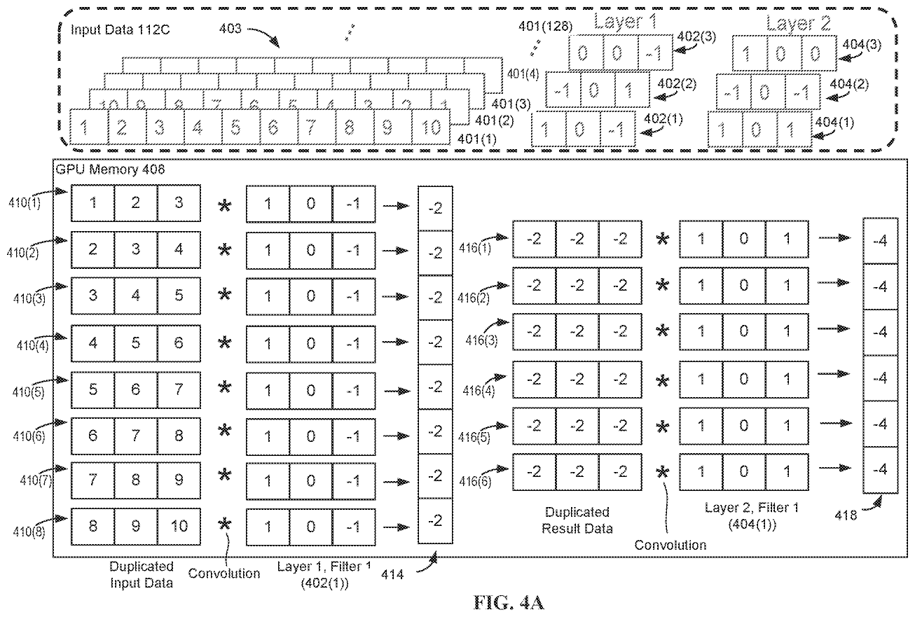

One technique disclosed herein for accelerating GPU computation is referred to herein as “duplicating data.” FIG. 4A depicts an embodiment of duplicating data to accelerate GPU computation. The input data 112C includes a batch 403 of data sets 401(1)-401(128). Each data set has ten elements, in this example. The numbers 1-10 represent the number of the element, as well as value of the data for that element in this example. Each data set 401 can be referred to as a data matrix.

The computational task includes Layer 1 and Layer 2. Layer 1 has filters 402(1)-402(3). Layer 2 has filters 404(1)-404(3). The filters are data that may be stored in a computable readable medium 112. Each filter at a given layer may be used in connection with a different computation. For example, filter 402(1) may be used in a convolution operation, filter 402(2) may be used a binary decision. At least some of the filters at layer 2 could be used in connection with the same type of computation as a filter in layer 1. For example, filters 402(1) and filter 404(1) may each be convolution filters, which are used in connection with a convolution operation. Thus, filter 402(1) and filter 404(1) can use the same set of instructions.

Dataset 401(1) is “duplicated” in the GPU memory 408. Duplicating provides access to over-lapping chunks of the data 401. Eight different sub-matrices 410(1)-410(8) are depicted. Each sub-matrices 410(1)-410(8) may be stored in a different region of the GPU memory 408. For example, elements 1-3 of sub-matrix 410(1) are stored in one region of GPU memory 408, elements 2-4 of sub-matrix 410(2) are stored in another region of the GPU memory 408, etc. Thus, at least some of the elements are stored in more than one location in GPU memory 408 (and hence duplicated). For example, the number “2” in 401(1) is duplicated once in 410(2), and the number “3” in 401(1) is duplicated twice in 410(2) and 410(3). Each of these units of three elements can be referred to as a sub-matrix 410, as it is some portion of the data matrix of one of the data sets 401. In an embodiment, the GPU memory 408 is non-transitory memory storage.

Hence, multiple sub-matrices 410 of a data matrix 401(1) are stored into the different regions of the GPU memory 408, which is accessible to a processor core of the GPU. Each sub-matrix 410 is therefore accessible to a different ALU in the processor core. Each sub-matrix 410 corresponds to a portion of the data matrix 401(1) for which an operation of the computational task is to be performed. Each sub-matrix 410 contains an element in the data matrix 401(1) in common with another sub-matrix. For example, sub-matrix 410(2) has elements 2 and 3 in common with sub-matrix 410(1), as well as having elements 3 and 4 in common with sub-matrix 410(3). Moreover, the sub-matrices 410 reside in the different regions of the GPU memory 408 at the same time to permit parallel computation in the ALUs.

In a conventional convolutional method, the Filter 402(1) is applied to data 401(1) by sliding the filter across 401(1) 3 numbers each time in sequence. To accelerate GPU operation, a convolution operation is performed on each of these sub-matrices to generate a result 414. The convolution operation applies filter 402(1), which is the Layer 1, Filter 1. The result 414 is an eight element vector in this example. The convolution is performed in parallel on each sub-matrix, which accelerates GPU operation. The convolution may be implemented by executing computational instructions in a GPU. The computational instructions may be stored in the GPU memory 408. In one embodiment, a processor core has a number of ALUs, such that each GPU executes the same computational instructions in parallel on the different sub-matrices. Hence, the duplication of the input data allows a GPU computation to be performed in parallel thereby accelerating computation 7 times faster in this example, assuming the time spending in duplicating data is too small to be counted comparing to the time spending in computation.

The result 414 of the convolution operation at Layer 1 is processed at another layer. Thus, the result 414 may serve as input data for Layer 2. Again, duplication may be used on the input data. Herein the duplication produces six sub-matrices 416(1)-416(6). In this example, the operation of filter 404(1) at Layer 2 is also convolution. The filter 404(1) at Layer 2 is then applied to the duplicated data (by executing the computational instructions for the convolution) to generate another result 418.

Due to the similarity of some of the operations in different layers, in some cases, the same set of computational instructions may be used for operations in different layers. An embodiment takes advantage of this commonality by “sharing” computational instructions across layers. For example, the convolution operations to 402(1) in Layer 1 and 404(1) Layer 2 are similar, and hence the same set of computational instructions may be used for both the operations of 402(1) in Layer 1 and 404(1) in Layer 2. Note that different filters may be used, however. This sharing of computational instructions accelerates GPU computation by, for example, avoiding the need to re-load the computational instructions. FIG. 11 depicts one embodiment of sharing a computational instructions across layers. The technique of sharing computational instructions is not limited to a CNN.

FIG. 4B depicts an embodiment of using pointers to accelerate GPU computation. In this embodiment, rather than copying the input data, pointers to the input data are used. In this manner, access to over-lapping chunks of the data 401 are provided to the GPU. GPU memory 408 has pointers 440(1)-440(8), which point to various places in data set 401(1). For example, pointer 440(1) points to element 1 in data set 401(1). In an embodiment, the pointers 440 are assigned to respective chunks of the input data by, for example, storing the pointers 440(1)-440(8) in the GPU memory 408.

Hence, multiple pointers 446 are stored into the different regions of the GPU memory 408, which is accessible to a processor core of the GPU. Each pointer 446 is therefore accessible to a different ALU in the processor core. Moreover, the multiple pointers 446 reside in the different regions of the GPU memory 408 at the same time to permit parallel computation in the ALUs. However, the matrix 401(1), which contains the sub-matrices, may reside in non-transitory memory storage external to the processor core (as well external as to the GPU). However, the processor core is able to use the pointers to obtain the data in the sub-matrices. Hence, the memory of the processor core (as well as GPU memory) need not be used to store the sub-matrices.

The results of the first convolution are stored in memory locations 436(1)-436(8). Pointers may also be used with respect to these results. GPU memory 408 has pointers 446(1)-446(6), which point to various locations of the results of the first convolution. For example, pointer 446(1) points to region 436(1). Filter 404(1) is applied to the data that is pointed to in order to produce results 448.

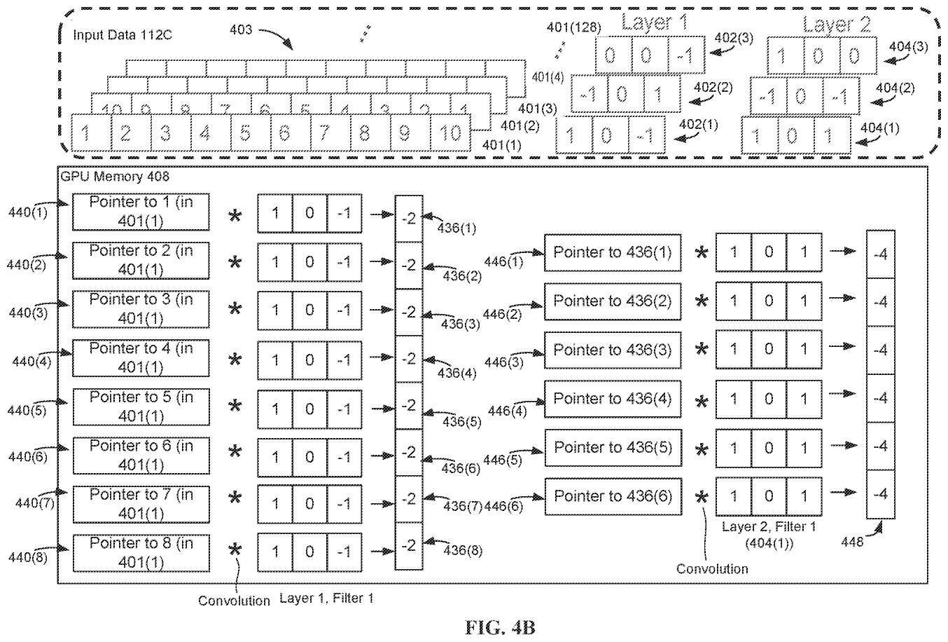

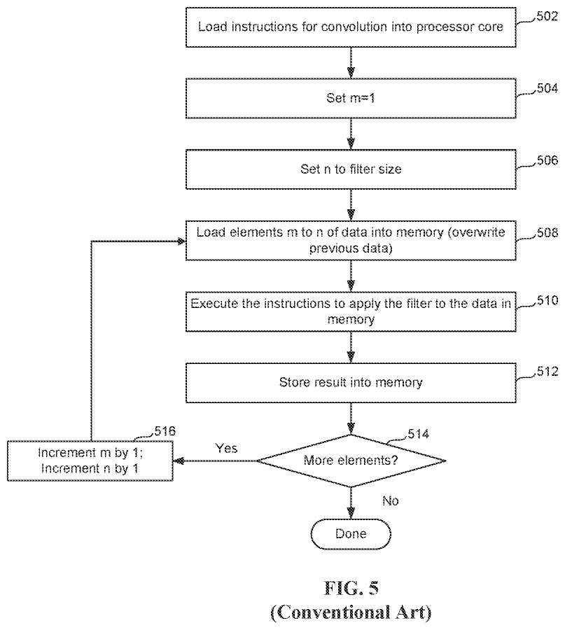

FIGS. 5 and 6 will now be discussed to describe one example of GPU acceleration. This example is for performing a convolution operation in a CNN. However, GPU acceleration as disclosed herein is not limited to either a convolution operation or to CNNs. FIG. 5 depicts a conventional art process of performing convolution in a CNN. This technique is slow due to the loop in which the convolution is executed many times (sequentially). Step 502 includes loading instructions for the convolution into a processor core of a GPU. Step 504 includes setting a first counter (m) to 1. Step 506 includes setting a second counter (n) to a filter size, which is also referred to as the filter dimension. The filter is the filter that will be used for the convolution operation. An example in which the filter has three elements will be discussed. In this example, the filter has one dimension for purpose of ease of explanation. However, the filter could have more than one dimension.

Step 508 includes loading elements m to n of data into memory that is accessible to the processor core. An example in which the data is data set 401(1) will be discussed. Thus, elements 1 to 3 of data set 401(1) are loaded into memory that is accessible to the processor core. Step 510 includes executing the instructions to apply the filter to the data that was loaded into memory. Step 512 includes storing the results into memory. Step 514 includes a determination of whether there are more elements in the data set to process. If so, then m and n are incremented by 1, in step 516. Then, step 508 is performed again. This time, elements 2 to 4 of data set 401(1) loaded into the memory. Also, the previous data may be overwritten. Step 510 and 512 are then performed to apply the computation to the next data.

Note that in the process of FIG. 5 that the computation in step 510 is performed a number of times in sequence. Hence, the conventional process of FIG. 5 is relatively slow.

FIG. 6 depicts an embodiment of duplicating data to accelerate GPU computation. This technique is fast due to: 1) duplicating the data; and 2) executing the computational instructions to apply a filter in parallel to the duplicated data. Step 602 includes loading instructions for the convolution operation into a processor core of a GPU. Step 604 includes setting a first counter (m) to 1. Step 606 includes setting a second counter (n) to the filter size, which is also referred to as the filter dimension. The filter refers to the filter associated with the convolution operation, and may be referred to as a convolution filter. An example in which the filter has three elements will be discussed. In this example, the filter has one dimension for purpose of ease of explanation. However, the filter could have more than one dimension.

Step 608 includes loading elements m to n of data into memory that is accessible to the processor core. These elements are referred to herein as a data chunk. In one embodiment, the data chunk is a sub-matrix. Step 610 includes determining whether more elements can be loaded into the memory. If so, control passes to step 612. Step 612 includes incrementing m by 1, as well as incrementing n by 1. An example in which the data is data set 401(1) will be discussed. With respect to FIG. 4A, the various sub-matrices 410(1) to 410(8) are loaded into the GPU memory 408. Thus, all of the sub-matrices 410(1) to 410(8) reside in the GPU memory 408 at the same time. Also note that the sub-matrices 410(1) to 410(8) are an example of over-lapping chunks of data. Further note that even more elements could be loaded into the GPU memory 408. For example, elements from data set 401(2) could be loaded. In some cases, there might not be enough GPU memory 408 for all elements of a data set 401 to be loaded. In this case, more data from the batch 403 can be loaded until there is no more GPU memory 408 available for the data.

Step 614 includes executing the instructions to apply the instructions in parallel to the data that was loaded into the GPU memory 408. The instructions will apply the filter to the data. Step 616 includes storing the results into GPU memory 408. Note that in the process 600 that the computation in step 614 is performed in parallel on many chunks of data. Hence, the process 600 accelerates computation in a GPU.

Process 600 is one embodiment of storing separate portions of information into corresponding different regions of non-transitory memory storage of a processor core to provide concurrent access to the multiple sub-matrices to the processor core. Process 600 is one embodiment of providing access to over-lapping chunks of data to a GPU for parallel operation of a set of the instructions on the over-lapping chunks. A variant of process 600 is to use pointers, as depicted in FIG. 4B, rather than to store the various sub-matrices 410 in the GPU memory 408, as depicted in FIG. 4A. Using pointers as depicted in FIG. 4B will also accelerate computation in a GPU and is also an example of providing access to over-lapping chunks of data to a GPU for parallel operation of a set of the instructions on the over-lapping chunks. In some embodiments, process 600 is modified by performing an operation other than convolution, such as a binary decision.

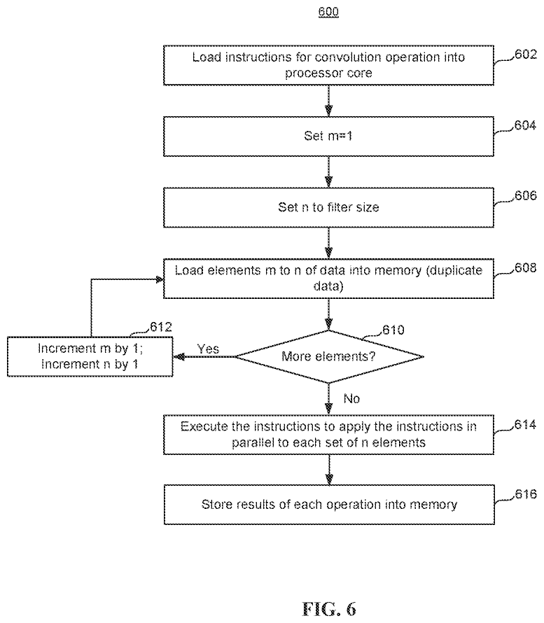

FIG. 7 is a flowchart of one embodiment of a process 700 of accelerating computation on a GPU 116. In one embodiment, process 700 is performed on a server 104 that has one or more GPUs 116. In one embodiment, some steps (e.g., step 702, 704, and/or step 706) are performed on a client device 102, and other steps are performed on a server 104. The steps are described in a certain order in order to facilitate explanation. It will be understood that the steps could be performed in a different order and the some steps may be performed in parallel with other steps.

Step 702 includes accessing input data 112C and computational instructions 112B for a computational task having a sequence of operations. In one embodiment, a client device 102 provides the input data 112C and computational instructions 112B to the server 104.

Step 704 includes pre-processing the input data 112C such that it is suitable for computation. Step 706 includes determining dynamic GPU resources. Over time, the GPU resources may change, which is what is meant by dynamic GPU resources. Process 700 adapts to these changing GPU resources to accelerate the performance GPUs. Step 706 may include determining that there has been a change in the number of GPUs, the number of ALUs, the amount of GPU memory, or some other GPU resources. Step 708 includes calculating a setup of data and instructions for GPU acceleration. Step 708 may include calculating how data should be duplicated to allow parallel execution in the GPU 116. Step 708 may include determining how to schedule computational instructions such that multiple operations in the computational task are performed by a set of the computational instructions in sequence. Step 708 may factor in the change to the GPU resources.

Step 710 includes loading the data and the computational instructions onto one or more GPUs per the allocation of step 708. Step 710 may include calculating an allocation of data and an allocation of the computational instructions for one or more GPUs based on the data, the computational instructions, and dynamic GPU resources. Step 710 may include providing the data and the instructions to the one or more GPUs in accordance with the allocation. In one embodiment, step 710 includes providing over-lapping chunks of data to a first GPU for parallel operation of a first set of computational instructions on the over-lapping chunks. In one embodiment, step 710 includes scheduling a second set of computational instructions on a second GPU for multiple operations of the computational task in sequence.

In embodiments, steps 708 and 710 are performed by GPU accelerator 112A. In one embodiment, the GPU accelerator 112A resides on a server 104 that has the GPU(s) 116 that execute the computational instructions. In one embodiment, the GPU accelerator 112A resides on a client device 102. Regardless of the location of the GPU accelerator, the client device 102 may provide the data 112C to the server, in embodiments. In an example in which the computational task includes image recognition, the data 112C may include images.

Step 712 includes performing the computational task on one or more GPUs 116. Step 712 includes executing the computational instructions 112B on the one or more GPUs.

Step 714 includes processing output of the computational task. The output may include intermediate results, such as results at one layer of the computational task. Results from one layer may be passed to another layer as input data.

Step 716 includes determining whether there is additional computation to be performed. If so, then control passes to step 708, which includes determining the dynamic GPU resources.

After the computation has completed (step 716 is yes), the output is finalized in step 718. In the image recognition example, finalizing the results may include indicating what object is in the image or whether a certain object was found in the image. For example, the computational task may include determining whether the image contains a cat, a dog, etc. The result of the computation may be accessed by the server 104 and provided to the client device 102. Hence, both the server 104 and client 102 may access the result of the computational task in response to execution of the computational instructions on the data 112C by the one or more GPUs 116.

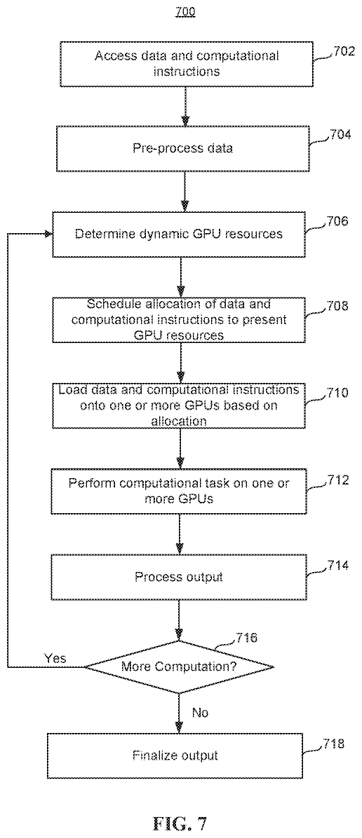

In one embodiment, computation on the GPU 116 is accelerated by maximizing computational instructions 112B for each processor core, and then maximizing the data allocated to each processor core. This helps to accelerate GPU performance by arriving at a good combination of data parallelism and model (instruction) parallelism. In an embodiment, once the computational instructions have finished executing the data can be removed from the GPU, which frees up the GPU memory for more data. FIG. 8 is a flowchart of one embodiment of a process 800 of accelerating of the performance of one of the GPUs. Step 802 includes monitoring for available GPU resources. Step 804 is to schedule computational instructions for a computation on a processor core. In one embodiment, step 804 includes scheduling a set of computational instructions for more than one computation on the same processor core of a GPU. For example, a set of computational instructions may be scheduled for a first convolution operation in a first layer of the computation task, and also for a second convolution operation in a second layer of the computation task. Herein, this referred to as “sharing the computational instructions” between layers of the computation task. Such sharing of the computational instructions accelerates computation in the GPU. For example, the computational instructions can be kept in the GPU between the two operations, which improves performance as the computational instructions need not be re-loaded into the GPU (and/or into a processor core of the GPU).

Step 806 is to load a data set based on computational instructions to be executed. Step 806 may include duplicating data as shown and described with respect to, for example, FIGS. 4A and 4B. In some embodiments, loading of the data continues until the GPU memory is full. Step 808 is to execute the computational instructions on the loaded data. Step 810 is a determination of whether more instructions should be scheduled for the current dataset in the core. In so, control passes to step 804. When there are no more instructions to be scheduled for the core (step 810 is no), control passes to step 812. Step 812 is a determination of whether to load more data for the current instructions in the core. If so, control passes to step 806 to load more data for the current instructions in the core. New GPU resources can become available anytime in cloud, and these resources can be allocated with data and instructions to finish the current computation tasks. Thus, unprocessed data can be sent to newly available GPUs. In addition, GPUs run fast but have small memory, i.e., data input/output is frequent in GPUs. Thus embodiments are designed to maximize the computation capacity (the use of ALU) first and minimize the data transfer in GPUs. Therefore, if there is a new set of instructions that can be applied to the current data and processing results in GPUs, the current data and processing results will stay in GPUs for new instructions. Hence, performing step 810 prior to step 812 achieves this and other benefits. If it is determined to not load more data for the current instructions in the core, then step 814 is performed. Step 814 includes collecting the outputs of the computations in the cores.

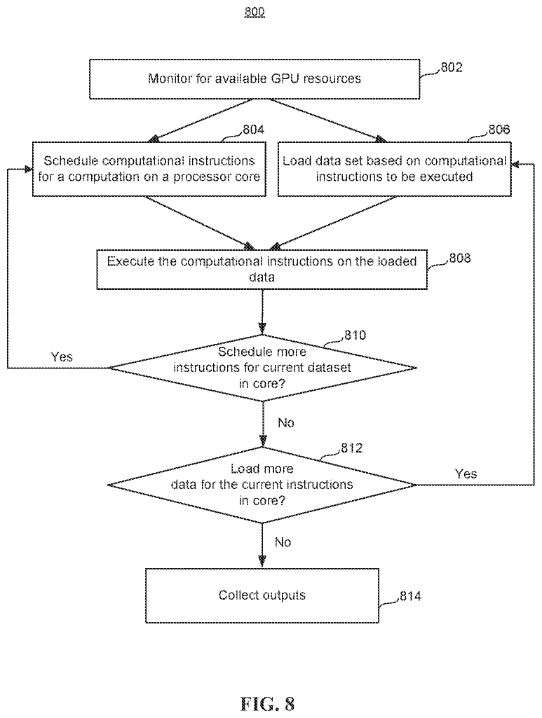

In some embodiments, the computational task includes a convolutional neural network (CNN). FIGS. 9-12 will now be discussed to describe embodiments in which the computational task includes a CNN. It will be appreciated that the computational task is not required to be a CNN.

FIG. 9 is a flowchart of one embodiment of a process 900 of performing computation for a CNN on a GPU 116 in which data is duplicated in order to accelerate performance on the GPU 116. Step 902 includes accessing a description of available GPU resources. This description may be provided by a server 104 that hosts the GPU 116. For example, client devices 102 are able to use the GPUs 116 for periods of time, upon receiving permission from the server. Hence, the GPU resources that are available to a particular client device may vary over time.

Step 904 includes accessing computational instructions 1128. In one embodiment, a client device 102 provides the computational instructions 1128 to a server 104 that hosts the GPU 116.

Step 906 includes accessing a matrix of data for which a computation is to be performed in the CNN. An example of the data matrix is one of the data sets 401. Step 908 includes calculating the limitations on the sizes of the sub-matrices according to instructions and specifications of GPU resources. Step 910 includes dividing, and copying if needed, the matrix into sub-matrices, according to limitation of step 908.

Step 912 includes storing multiple sub-matrices from the matrix into GPU memory. An example of storing multiple sub-matrices is depicted in FIG. 4A, in which sub-matrices 410(1)-410(8) are stored in GPU memory 408. In another embodiment, rather than storing the sub-matrices in the GPU memory, pointers to the sub-matrices are stored in GPU memory 408. An example of storing pointers to sub-matrices is depicted in FIG. 4B, in which pointers 440(1)-440(8) are stored in GPU memory 408. Step 912 is one embodiment of “duplicating data” for GPU acceleration. Step 912 is one embodiment of, providing over-lapping chunks of the data to a first GPU for parallel operation of a first set of the instructions on the over-lapping chunks.

Step 914 includes executing computational instructions 112B on the processor core of the GPU to simultaneously apply the convolutional filter to each sub-matrix. Step 916 includes storing a result of the computation.

FIG. 10 is a flowchart of one embodiment of a process 1000 of executing multiple operations for the same layer of a CNN on the same data set. The process is one embodiment of maximizing instructions that are executed on a processor core. Step 1002 includes loading a data set 401 onto GPU memory 408. Step 1004 includes loading a first set of computational instructions 112B for a first operation for a layer of a CNN. The first operation may be, for example, a convolution. Step 1006 includes executing the set of computational instructions 112B for the operation for the layer of the CNN. Step 1008 includes storing results of this computation. Step 1010 includes a determination of whether there are more operations for this layer of the CNN for the data set that was loaded in step 1002. If so, then the next set of computational instructions 112B to perform the next operation are loaded in step 1012. For example, a set of computational instructions to perform a binary decision are loaded into the GPU memory. Next, this new set of computational instructions are executed on the GPU, in step 1006. Note that this new set of computational instructions is executed on the same data set as the first set of computational instructions, which is one way of maximizing instructions on the GPU. The process 1000 may continue until there are no more operations for this layer of the CNN for this data set. Then, the GPU memory that is used to store the data set may be freed in step 1014. Step 1016 includes a determination of whether there are more operations for this layer of the CNN. Step 1018 includes loading a next set of instructions to perform a next operation for the layer of the CNN. Control then passes to step 1006. In some embodiments of process 1000, the computational instructions that are executed in step 1006 are executed on the same processor core of the GPU.

FIG. 11 is a flowchart of one embodiment of a process 1100 of sharing computational instructions across layers of a CNN. As one example, the process 1100 could be used to perform convolution at Layer 1 to generate a result, and then perform convolution at Layer 2 on the result from Layer 1 (see, FIG. 4A or 4B). The process 1100 is one embodiment of maximizing instructions that are executed on a processor core of a GPU 116.

Step 1102 includes loading a set of computational instructions into memory of a processor core of a GPU 116. Step 1104 includes executing the computational instructions 112B on the processor core to perform a computation at Layer 1 on a first data set. For example, with respect to FIG. 4A, convolution is performed on the sub-matrices 410 in the GPU memory 408. With respect to either FIG. 4B convolution is performed on the sub-matrices in data set 401(1) that are pointed to by pointers 440(1)-440(8).

Step 1106 includes storing the results of the Layer 1 computation. For example, with respect to FIG. 4A, the result 414 is stored in GPU memory. Step 1108 is to keep the computational instructions in memory of the processor core. Step 1110 includes executing the computational instructions 112B on the processor core to perform a computation at Layer 2 on a second data set. For example, with respect to FIG. 4A convolution is performed on the sub-matrices 416 in the GPU memory 408. With respect to either FIG. 4B convolution is performed on the sub-matrices in results 436 that are pointed to by pointers 446(1)-446(8). Hence, the computational instructions are shared by a first operation in the Layer 1 and second operation the Layer 2. Sharing the computational instructions accelerates GPU computation, at least due to not off-loading and re-loading the computational instructions 112B.

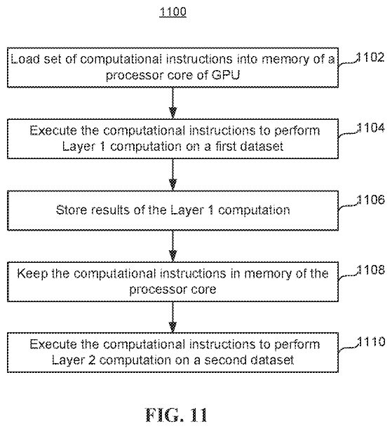

FIG. 12 is a flowchart of one embodiment of a process 1200 of loading data into memory on a processor core. The process is one embodiment of step 1002 of FIG. 10. The process 1200 is one embodiment of maximizing data to be processed on a processor core. Step 1202 of process 1200 includes accessing a data set for which one or more computations at a layer of a CNN are to be performed. Step 1204 includes determining a number of available ALUs and GPU memory for a processor core. Step 1206 includes determining a size of data units for the data set. The size of the data units may depend on the filter size, the number of ALUs, the amount of GPU memory, and/or the amount of GPU memory needed by computational instructions 112B. Steps 1204-1206 are one embodiment of steps 908-910 of FIG. 10. Step 1208 includes loading each data unit into memory that is accessible to a respective ALU.

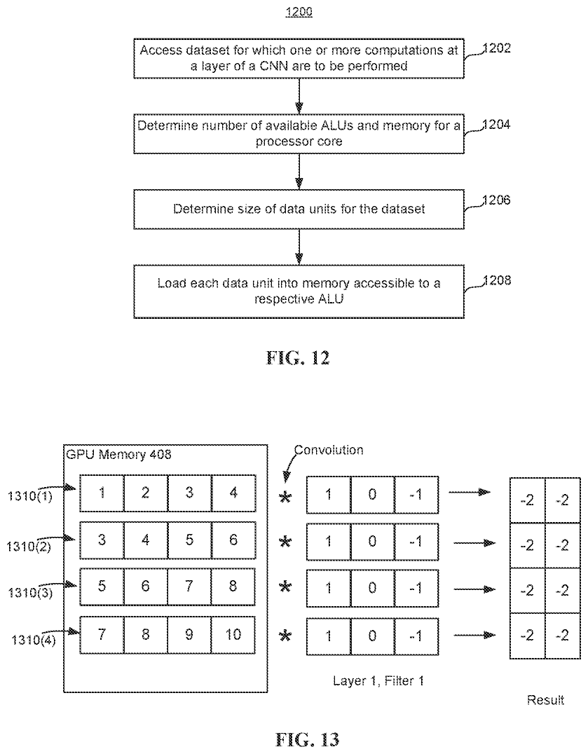

One factor in how the data gets loaded (and duplicated) is the size of the filter associated with the operation that is implemented by the computational instructions. In an embodiment, the sub-matrices (see 410, FIG. 4A) should be at least as large as the filter (3 elements in the example of FIG. 4A). However, the sub-matrices could be larger than the filter. Another factor in how the data gets loaded (and duplicated) is the number of ALUs that are available. For example, in the example of FIG. 4A, if there were only four ALUs available, then there would be only four sub-matrices 410, in an embodiment. Another factor in how the data gets loaded (and duplicated) is the amount of memory available in the processor core. For example, in the example of FIG. 4A, if there was not enough memory for all eight sub-matrices 410(1)-410(8), then some memory can be saved by using larger sub-matrices. FIG. 13 depicts such an example in which four sub-matrices 1310(1)-1310(4) are loaded into GPU memory 408. Each convolution operation will produce two results. Note that if the sub-matrices in FIG. 13 only had 3 elements each (as in FIG. 4A), then this would not be “maximizing the data” to that processor core. In one embodiment, “maximizing the data” means to maximize the amount of input data that gets loaded given one or more of: filter size, number of available ALUs, amount of GPU memory available, and/or amount of GPU memory needed by the computational instructions scheduled for the GPU. Maximizing the data could also apply to an intermediate layer, and hence is not limited to the input data.

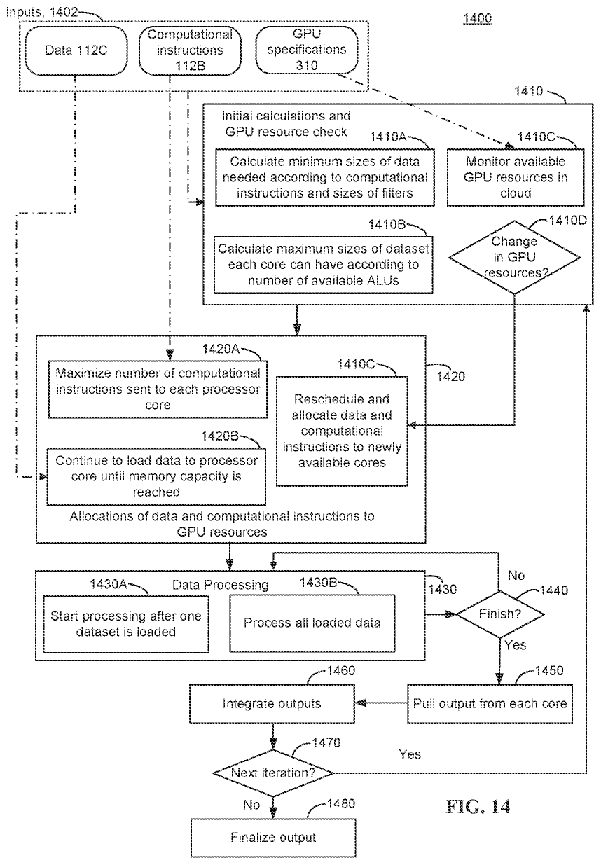

FIG. 14 is a flowchart of one embodiment of a process 1400 of GPU acceleration in a cloud setting, where the GPU resources are consistently changing (i.e., dynamic). The process 1400 has several inputs 1402. The inputs include the input data 112C, the computational instructions 112B, and GPU specifications 310. Dashed arrows in FIG. 14 represent steps of the process 1400 in which the input is used. Solid arrows in FIG. 14 represent a transition from one step to another step.

Step 1410 includes initial calculations and a GPU resource check. Step 1410 may factor in the data 112C, the computational instructions 1128, and the GPU specifications 310. The initial calculations include a step 1410A of calculating minimum sizes of data needed according to computational instructions 1128 and sizes of filters. The initial calculations also include a step 1410B of calculating maximum sizes of data set each core can have according to available memory. The GPU resource check includes a step 1410C of monitoring available GPU resources in a cloud. The cloud refers to computer resources made available by a server to client devices over a network. The GPU resources may be monitored consistently, which means that that the monitoring is ongoing during the execution of the computational instructions on the GPU(s) 116. Step 1410D is a determination of whether there is a change in the GPU resources. In one embodiment, step 1410C includes monitoring GPU resources in one or more servers 104 by communicating over a communication network 106 with the one or more servers 104 to obtain latest information about available GPU resources in the one or more servers 104. In one embodiment, the monitoring is performed by a server 104 in which the computational task is presently being executed. Step 1410C may also include obtaining permissions to use GPU resources outside of the server that is presently executing the computational task. 410C may also include obtaining specifications of newly available GPU resources.

Step 1420 includes an allocation of the data and the computational instructions to the GPU resources. Step 1420 includes a step 1420A of maximizing the number of computational instructions sent to each processor core. Step 1420 includes a step 1420B of continuing to load data to processor core until memory capacity is reached. In the event that there is a change in the GPU resources (see step 1410D), then, step 1410C includes rescheduling and allocating the data and the computational instructions to newly available cores. FIG. 8 shows part of one embodiment of step 1420 in detail.

Step 1430 includes data processing. Step 1430 includes step 1430A, which is to start processing after one data set is loaded in the GPU memory. After step 1430 is a determination of whether all the loaded data has been processed. Step 14308 indicates that processing continues until all of the data that was loaded in step 1420B is processed. After step 1430 is complete (as determined by step 1440), the output is pulled from each processor core (of the one or more GPUs), in step 1450. In step 1460, the outputs of the processor cores is integrated. Step 1470 is a determination of whether another iteration is to be performed. If so, control passes to step 1410. Hence, if there is a change in the GPU resources, there may be re-scheduling of re-allocations of instructions and data. After all iterations are performed (step 1470 is no), the process concludes with a step 1480 of finalizing the output.

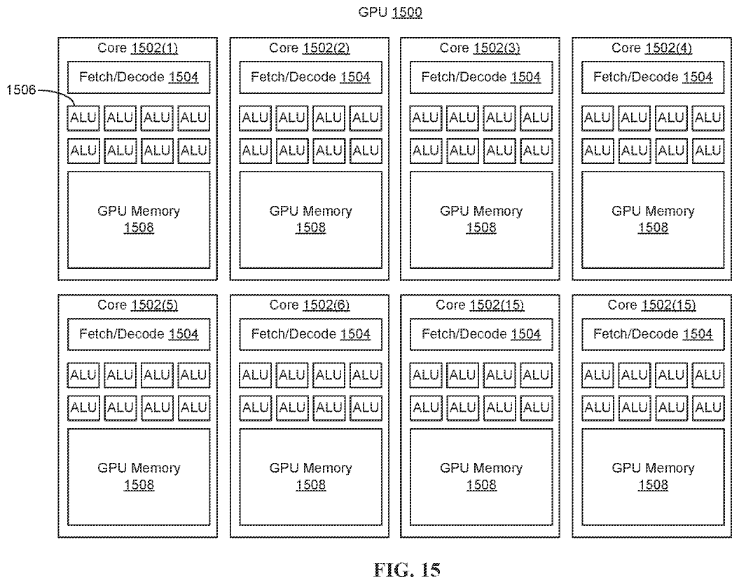

FIG. 15 depicts an example GPU 1500. The GPU 1500 has eight processor cores 1502(1)-1502(8) in this example, but could have more or fewer cores 1502. Each core 1502 has a fetch/decode unit 1504, which is configured to fetch and decode instructions, which may include the computational instructions 1128. Each core 1502 has a number of arithmetic logic units (ALU). In this example, there are eight ALUs 1506 per core 1502, but there may be more or fewer. Each core 1502 has GPU memory 1508. In some embodiments, a portion of the GPU memory 1508 may be used exclusively by an ALU 1506. In an embodiment, the GPU memory 1508 is non-transitory memory storage. There are many different types of architectures for GPUs, hence, GPU acceleration as described herein is not limited to the example in FIG. 15.

In embodiments, the ALUs of a processor core perform parallel computation on different data. For example, the ALUs may perform parallel computation on different sub-matrices. The processor core may execute a set of computing instructions for some operation, such as convolution. Hence, a process such as process 600 may be performed in a processor core. In step 614, the ALUs of a processor core perform parallel computation on different sub-matrices. In one embodiment, the different sub-matrices are stored in the GPU memory of the processor core. In one embodiment, pointers to the different sub-matrices are stored in the GPU memory of the processor core.

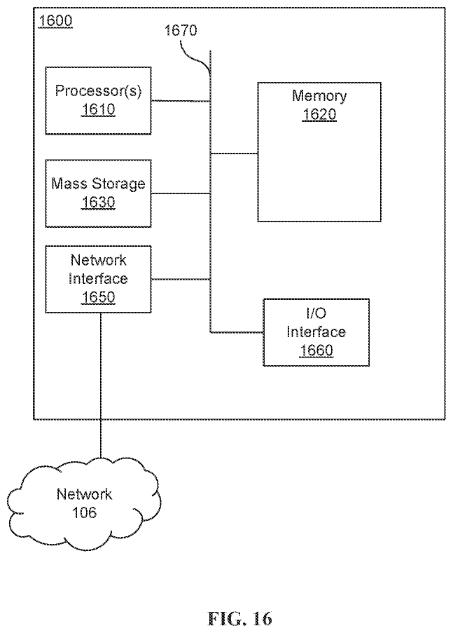

FIG. 16 is an example of a computer system 1600 upon which embodiments of the disclosure may be implemented. The computer system 1600 may be used within any of computing devices 102 or servers 104 in FIG. 1. In one embodiment, the GPU accelerator 112A is implemented on computer system 1600. Computing system 1600 may be programmed (e.g., via computer program code or instructions) to provide GPU acceleration as described herein.

The computer system 1600 may contain multiple instances of a component, such as multiple processing units, processors, memories, transmitters, receivers, etc. The computer system 1600 may include one or more processors 1610, a memory 1620, a mass storage device 1630, a network interface 1650, and an I/O interface 1660 connected to a bus 1670. In an embodiment, the one or more processors 1610 includes GPU 1500 (see FIG. 15). The one or more processors 1610 may also include one or more central processing units (CPU). The bus 1670 may be one or more of any type of several bus architectures including a memory bus or memory controller, a peripheral bus or the like.

The memory 1620 may comprise any type of system memory such as static random-access memory (SRAM), dynamic random-access memory (DRAM), synchronous DRAM (SDRAM), read-only memory (ROM), a combination thereof, or the like. In an embodiment, the memory 1620 may include ROM for use at boot-up, and DRAM for program and data storage for use while executing programs. In embodiments, the memory 1620 is non-transitory (e.g., non-transitory memory storage).

The mass storage device 1630 may comprise any type of storage device configured to store data, programs, and other information and to make the data, programs, and other information accessible via the bus 1670. The mass storage device 1630 may comprise, for example, one or more of a solid-state drive, hard disk drive, a magnetic disk drive, an optical disk drive, or the like.

The mass storage device may comprise computer-readable non-transitory media which includes all types of computer readable media, including magnetic storage media, optical storage media, and solid-state storage media and specifically excludes signals. It should be understood that the software can be installed in and sold with the computer system 1600. Alternatively the software can be obtained and loaded into computer system 1600, including obtaining the software via a disc medium or from any manner of network or distribution system, including, for example, from a server owned by the software creator or from a server not owned but used by the software creator. The software can be stored on a server for distribution over the Internet, for example.

The computer system 1600 also includes one or more network interfaces 1650, which may comprise wired links, such as an Ethernet cable or the like, and/or wireless links to access nodes or one or more networks 106. The network interface 1650 allows the computer system 1600 to communicate with remote units via the networks 106.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the following detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for accelerating computation in graphic processing units (GPUs), the method comprising:
accessing instructions for a computational task having a sequence of operations;
calculating an allocation of data and an allocation of the instructions for the GPUs based on the data, the instructions, and dynamic GPU resources, wherein the data comprises a plurality of data matrices upon which the operations are to be performed;
providing the data and the instructions to the GPUs in accordance with the allocation, including:
i) scheduling a first set of the instructions for parallel computation of a first operation of the computational task on multiple sub-matrices of a first data matrix of the plurality of data matrices, the first set of the instructions scheduled for execution in a first processor core of a plurality of processor cores in a first GPU, wherein each processor core comprises arithmetic logic units (ALUs) and non-transitory memory storage, wherein the first set of the instructions are scheduled for parallel computation in the ALUs; and
ii) storing separate portions of information into corresponding different regions of the non-transitory memory storage of the first processor core to provide concurrent access to the multiple sub-matrices to the first processor core, wherein:
each portion of information provides access to a different ALU to a different sub-matrix of the first data matrix,
each sub-matrix corresponds to a portion of the first data matrix for which a first operation of the computational task is to be performed,
each sub-matrix contains an element in the first data matrix in common with another sub-matrix of the first data matrix, and
the separate portions of information reside in the different regions of the non-transitory memory storage at the same time; and
accessing a result of the computational task in response to execution of the instructions on the data by the GPUs.

2. The computer-implemented method of claim 1, further comprising:
monitoring the resources of the GPUs as the instructions are executed on the data by the GPUs; and
adjusting the allocation of the data and the instructions based on a change in available GPU resources.

3. The computer-implemented method of claim 1, wherein providing the data and the instructions to the GPUs in accordance with the allocation further comprises:
identifying instructions that are sharable between a first operation in a first layer of the computational task and a second operation in a second layer of the computational task; and
scheduling the sharable instructions to be executed on the first GPU without removal of the sharable instructions between computation for the first operation and the second operation.

4. The computer-implemented method of claim 1, wherein storing separate portions of information into corresponding different regions of the non-transitory memory storage of the first processor core to provide concurrent access to the multiple sub-matrices to the first processor core comprises:
storing the multiple sub-matrices of the first data matrix into the different regions of the non-transitory memory storage that is accessible to the first processor core.

5. The computer-implemented method of claim 4, further comprising:
retaining the multiple sub-matrices in the different regions of the non-transitory memory storage after the first set of the instructions are executed on the first processor core;
scheduling a second set of the instructions for parallel computation of a second operation of the computational task in the first processor core, wherein the second set of the instructions are scheduled for parallel computation in the ALUs; and
initiating execution of the second set of the instructions in the first processor core to simultaneously apply the second set of the instructions to the multiple sub-matrices while the multiple sub-matrices are maintained in the different regions of the non-transitory memory storage.

6. The computer-implemented method of claim 1, wherein storing separate portions of information into corresponding different regions of the non-transitory memory storage of the first processor core to provide concurrent access to the multiple sub-matrices to the first processor core comprises:
storing pointers in the different regions of the non-transitory memory storage of the first processor core, wherein each pointer points to a different sub-matrix of the multiple sub-matrices, wherein the pointers reside in the different regions of the non-transitory memory storage at the same time, wherein the multiple sub-matrices reside in non-transitory memory storage external to the first processor core.

7. The computer-implemented method of claim 1, further comprising:
selecting a size of the multiple sub-matrices based on an amount of non-transitory memory storage that is available in the first processor core.

8. The computer-implemented method of claim 1, further comprising:
selecting a size of the multiple sub-matrices based on an amount of memory needed by the first set of instructions that will be applied to data of the multiple sub-matrices.

9. The computer implemented method of claim 1, further comprising:
monitoring over a communication network, GPU resources in a server that hosts the GPUs by communicating over the communication network with the server to obtain latest information about available GPU resources in the server;
accessing specifications of newly available GPU resources;
calculating an allocation of the data remains to be processed and an allocation of the instructions that remain to be processed to finish a current computational task in GPUs, including newly available GPUs; and
providing the data remains to be processed and the instructions that remain to be processed to the GPUs, including newly available GPUs, in accordance with the allocation of the data remains to be processed and the allocation of the instructions that remain to be processed.

10. The computer implemented method of claim 1, further comprising:
communicating, by a first server that hosts the GPUs with a second server over a communication network, to obtain information of GPU resources on the second server;
obtaining permissions to use the GPU resources on the second server;
calculating an allocation of the data remains to be processed and an allocation of the instructions that remain to be processed based on the GPU resources on both the first server and the second server;
providing a first portion of the data remain to be processed and a first portion of the instructions that remain to be processed to the GPUs in the first server based on the allocation of the data remains to be processed and the allocation of the instructions that remain to be processed; and
providing a second portion of data remain to be processed and a second portion of the instructions that remain to be processed to the GPUs in the first server based on the allocation of the data remains to be processed and the allocation of the instructions that remain to be processed.

11. The computer-implemented method of claim 1, further comprising:
identifying types of parallelization that can be performed among the data and among the instructions;
calculating data and instructions that are needed to implement parallelizations with constraints of GPU availability and specifications, wherein the GPU availability and specifications identify available processor cores in the GPUs;
calculating a minimum size of data needed for a set of instructions in each processor core; and
calculating a maximum size of data set each processor core can have according to a number of available processor cores.

12. The computer-implemented method of claim 1, wherein the computational task comprises an artificial neural network.

13. A non-transitory computer-readable medium storing computer executable instructions for accelerating computation in graphics processing units (GPUs) that, when executed by one or more processors, cause the one or more processors to:
access computational instructions for a computational task having a sequence of operations;
calculate an allocation of data and an allocation of the computational instructions for the GPUs based on the data, the computational instructions, and dynamic GPU resources, wherein the data comprises a plurality of data matrices upon which the operations are to be performed;
provide the data and the computational instructions to the GPUs in accordance with the allocation, including:
i) schedule a first set of the computational instructions for parallel computation of a first operation of the computational task on multiple sub-matrices of a first data matrix of the plurality of data matrices, the first set of the computational instructions scheduled for execution in a first processor core of a plurality of processor cores in a first GPU, wherein each processor core comprises arithmetic logic units (ALUs) and non-transitory memory storage, wherein the first set of the computational instructions are scheduled for parallel computation in the ALUs; and
ii) store separate portions of information into corresponding different regions of the non-transitory memory storage of the first processor core to provide concurrent access to the multiple sub-matrices to the first processor core, wherein:
each portion of information provides access to a different ALU to a different sub-matrix of the first data matrix,
each sub-matrix corresponds to a portion of the first data matrix for which a first operation of the computational task is to be performed,
each sub-matrix contains an element in the first data matrix in common with another sub-matrix of the first data matrix, and
the separate portions of information reside in the different regions of the non-transitory memory storage at the same time; and
access a result of the computational task in response to execution of the computational instructions on the data by the GPUs.

14. The non-transitory computer-readable medium of claim 13, wherein the computer executable instructions, when executed by the one or more processors, cause the one or more processors to:
monitor the resources of the GPUs; and
adjust the allocation of the data and the computational instructions based on a change in available GPU resources.

15. The non-transitory computer-readable medium of claim 13, wherein the computer executable instructions, when executed by the one or more processors, cause the one or more processors to:
identify computational instructions that are sharable between a first operation in a first layer of the computational task and a second operation in a second layer of the computational task; and
schedule the sharable computational instructions to be executed on the first GPU without removal of the sharable computational instructions between computation for the first operation and the second operation.

16. The non-transitory computer-readable medium of claim 13, wherein the computer executable instructions, when executed by the one or more processors, cause the one or more processors to:
store the multiple sub-matrices of the first data matrix into the different regions of the non-transitory memory storage that is accessible to the first processor core.

17. The non-transitory computer-readable medium of claim 16, wherein the computer executable instructions, when executed by the one or more processors, cause the one or more processors to:
retain the multiple sub-matrices in the different regions of the non-transitory memory storage after the first set of the computational instructions are executed on the first processor core;
schedule a second set of the computational instructions for parallel computation of a second operation of the computational task in the first processor core, wherein the second set of the computational instructions are scheduled for parallel computation in the ALUs; and
initiate execution of the second set of the computational instructions in the first processor core to simultaneously apply the second set of the instructions to the multiple sub-matrices while the multiple sub-matrices are maintained in the different regions of the non-transitory memory storage.

18. The non-transitory computer-readable medium of claim 13, wherein the computer executable instructions, when executed by the one or more processors, cause the one or more processors to:
store pointers in the different regions of the non-transitory memory storage of the first processor core, wherein each pointer points to a different sub-matrix of the multiple sub-matrices, wherein the pointers reside in the different regions of the non-transitory memory storage at the same time, wherein the multiple sub-matrices reside in non-transitory memory storage external to the first processor core.

19. The non-transitory computer-readable medium of claim 13, wherein the computer executable instructions, when executed by the one or more processors, cause the one or more processors to:
select a size of the multiple sub-matrices based on at least one of:
i) an amount of non-transitory memory storage that is available in the first processor core; and
ii) a size of a filter that is applied to data in the multiple sub-matrices.

20. A system for accelerating computation of graphics processing units (GPUs), the system comprising:
a non-transitory memory storage comprising computer executable instructions; and
one or more processors in communication with the non-transitory memory storage, wherein the one or more processors execute the computer executable instructions to:
access computational instructions for a computational task having a sequence of operations;
calculate an allocation of data and an allocation of the computational instructions for the GPUs based on the data, the computational instructions, and dynamic GPU resources, wherein the data comprises a plurality of data matrices upon which the operations are to be performed;
provide the data and the computational instructions to the GPUs in accordance with the allocation, including:
i) schedule a first set of the computational instructions for parallel computation of a first operation of the computational task on multiple sub-matrices of a first data matrix of the plurality of data matrices, the first set of the computational instructions scheduled for execution in a first processor core of a plurality of processor cores in a first GPU, wherein each processor core comprises arithmetic logic units (ALUs) and non-transitory memory storage, wherein the first set of the computational instructions are scheduled for parallel computation in the ALUs; and
ii) store separate portions of information into corresponding different regions of the non-transitory memory storage of the first processor core to provide concurrent access to the multiple sub-matrices to the first processor core, wherein:
each portion of information provides access to a different ALU to a different sub-matrix of the first data matrix,
each sub-matrix corresponds to a portion of the first data matrix for which a first operation of the computational task is to be performed,
each sub-matrix contains an element in the first data matrix in common with another sub-matrix of the first data matrix, and
the separate portions of information reside in the different regions of the non-transitory memory storage at the same time; and
access a result of the computational task in response to execution of the computational instructions on the data by the GPUs.
